(19) United States
(12) Patent Application Publication
(10) Pub. No.: US 2012/0260018 A1
(43) Pub. Date: Oct. 11, 2012

(54) KVM SWITCHER WITH ABILITY TO EXTEND UNIVERSAL SERIAL BUS (USB) HOST INTERFACE VIA SERIAL PERIPHERIAL INTERFACE (SPI)

(75) Inventor: Chun Tse LIN, New Taipei City (TW)

(73) Assignee: OCT TECHNOLOGY CO.,LTD., New Taipei City (TW)

(21) Appl. No.: 13/080,681

(22) Filed: Apr. 6, 2011

(51) Int. Cl. G06F 13/00

(52) U.S. Cl. 710/316

(57) ABSTRACT

A multi-computer (KVM) switcher with ability to extend universal serial bus (USB) host interface via serial peripheral interface (SPI), characterized in that SPI master device interface of master control unit can switch the capability of controlling plural SPI slave devices via serial peripheral interface (SPI), and through installing SPI slave device interfaces on plural universal serial bus (USB) host interface control units to be extended, the object of extending peripheral device with USB interface via SPI interface is achieved.

### BACKGROUND OF THE INVENTION

1. Technical Field

The present invention relates to a KVM switcher with ability to extend USB host interface via serial peripheral interface (SPI), especially to the KVM switcher, in which a SPI master control unit switches at least one USB host interface control unit through communication protocol of serial peripheral interface.

2. Description of the Related Art

The conventional multi-computer (Keyboard/Video/Mouse, KVM) switcher can switch and share a group of peripheral devices, including a keyboard, a mouse, a screen, or even a microphone, a speaker, an USB disk, a storage device, and any peripheral devices with universal serial bus (USB) interface, among plural computers, so that users can control plural computers or share resources through only one group of peripheral devices prepared, by way of selecting and switching by the KVM switcher from the connections between the peripheral devices and computers. In the conventional KVM switcher, USB switching system is constituted by a control unit and an USB hub. However, the number of the USB slot on the chip of the USB host interface control unit is limited, thus the number of the related USB host interface control unit will be extended as the number of the USB slot to be extended, it also means that more complicated circuits are needed for achieving switching operation among plural USB host interface control units, and it results in cost increasing.

On the other hand, the conventional serial peripheral interface, which is abbreviated to “SPI”, is a four-line synchronous serial data communication protocol, and employs the master-slave architecture; under such architecture, the SPI device is classified as SPI master device and SPI slave device. Generally, one SPI master device combines with plural SPI slave devices. The SPI master device sends a control signal and selects which SPI slave device should receive data, when communication. The SPI not only has the advantage of full-duplex, but also performs communication with high bandwidth and synchronous signals. In addition, there also are characteristics of brief circuit, simple control and easy operation.

In spite of many advantages of the conventional SPI, which are suitable for the switching system, but are not applied to a KVM switcher, in which the KVM switcher extends the USB host interface capability via the serial peripheral interface (SPI).

The conventional technique has the following disadvantages:

1. In the conventional KVM switcher, the USB switching system is constituted by the control unit and the USB hub, and does not employ the SPI communication protocol suitable for switching system;

2. The conventional USB switching system does not employ the SPI communication protocol, therefore, the advantages of SPI, including full-duplex, high bandwidth, brief circuit, and simple control, do not exist; and

3. For extending the number of the USB slot to be switched, the corresponding number of the USB host interface control unit is needed for the KVM, it also means that more complicated circuits are needed for achieving switching operation among plural USB host interface control units, and it results in cost increasing.

Accordingly, the present invention concerns to overcome the above disadvantages in the conventional technique, perform the switching function of the USB device through the SPI communication protocol, and accordingly extend the number of the USB slot.

### SUMMARY OF THE INVENTION

A KVM switcher with ability to extend USB host interface via serial peripheral interface (SPI) employs the SPI to connect to a SPI master control unit, an USB host interface control unit, and at least one USB device control unit, whereby to control the connection relationship between the USB host interface control unit and the at least one USB device control unit through the SPI communication protocol, to perform the switching effect, and to achieve the object of extending the number of the USB interface slot.

For achieving the above objects, the present invention provides a multi-computer (KVM) switcher with ability to extend the universal serial bus (USB) host interface via the serial peripheral interface (SPI), including:

a serial peripheral interface (SPI) master control unit, equipped with a SPI master device interface; and

at least one universal serial bus (USB) host interface control unit, equipped with an USB interface connecting to at least one peripheral device with USB interface, and equipped with SPI and SPI slave device interface connecting to the SPI master device interface of the serial peripheral interface (SPI) master control unit; characterized in that the SPI master device interface of the master control unit can switch the capability of controlling the plural SPI slave devices via serial peripheral interface (SPI), and through installing the SPI slave device interface on the plural universal serial bus (USB) host interface control units to be extended, the object of extending peripheral device with USB interface via SPI interface is achieved. The multi-computer (KVM) switcher further includes at least one USB device control unit, and the USB device control unit directly or indirectly electrically connects to a computer, and is equipped with a SPI slave device interface, and the SPI slave device interface of each of the USB device control unit electrically connects to the SPI master device interface of the SPI master control unit, and the SPI slave device interface of the USB host interface control unit. The SPI master control unit, the USB host interface control unit, and the at least one USB device control unit communicate via SPI signals; the SPI master control unit can switch and select a specific USB device control unit among the at least one USB device control unit, and assign the signal of the USB host interface control unit to the specific USB device control unit, so that the peripheral device with USB interface connecting to the USB host interface control unit can connect to the computer corresponding to the specific USB device control unit. The peripheral device with USB interface is a keyboard with USB interface or a mouse with USB interface. Plural USB hubs are further included, and electrically connect to the at least one USB device control unit, respectively, and the at least one USB device control unit indirectly electrically connects to the corresponding computer through the at least one USB hub. An USB switch is further included, electrically connects to the SPI master control unit and the at least one USB hub, and connects to the at least one device with universal serial bus (USB) interface, and the SPI master control unit can control the USB switch to assign the signal of the device with universal serial bus (USB) interface to the at least one USB hub. The device with USB interface is a storage device with USB interface.

### BRIEF DESCRIPTION OF THE DRAWINGS

FIG. 1 is a schematic view, showing an embodiment of a KVM switcher with ability to extend USB host interface via serial peripheral interface (SPI) according to the present invention; and

FIG. 2 is a schematic view, showing an embodiment of the KVM switcher applying a KVM switcher to extend USB host interface via serial peripheral interface (SPI) according to the present invention.

### DETAILED DESCRIPTION OF THE INVENTION

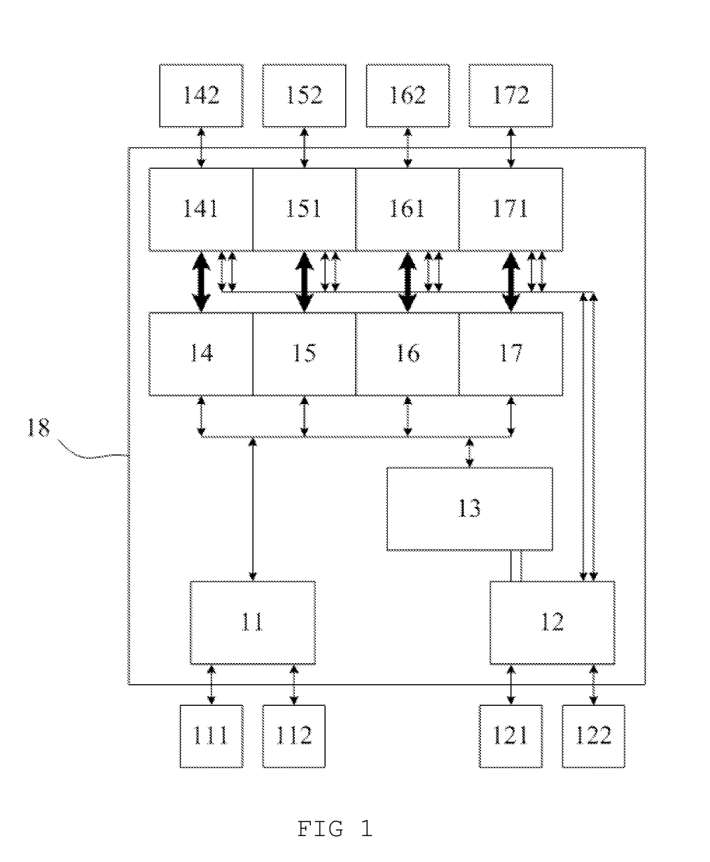

FIG. 1 is a schematic view, showing an embodiment of a KVM switcher with ability to extend USB host interface via serial peripheral interface (SPI) according to the present invention, including an USB host interface control unit 11, a keyboard with USB interface 111, a mouse with USB interface 112, an USB switch 12, storage devices with USB interface 121 and 122, a SPI master control unit 13, USB device control units 14, 15, 16 and 17, USB hubs 141, 151, 161 and 171, computers 142, 152, 162 and 172, and a KVM switcher 18 with ability to extend USB host interface via serial peripheral interface (SPI). In the KVM switcher 18 with ability to extend USB host interface via serial peripheral interface (SPI) provided in the present invention, the USB host interface control unit 11 can connect to plural peripheral devices with USB interface, such as the keyboard with USB interface 111, the mouse with USB interface 112, and the like. The USB device control units 14, 15, 16 and 17 electrically connect to the USB hubs 141, 151, 161 and 171, respectively, and the USB hubs 141, 151, 161 and 171 connect to the computers 142, 152, 162 and 172, respectively. The SPI master control unit 13 has the SPI master device interface, and the USB host interface control unit 11, and the USB device control units 14, 15, 16 and 17 all have the SPI slave device interface, and electrically connect to each other via the SPI and the SPI master device interface of the SPI master control unit 13. The SPI master control unit 13 controls to assign the signal of the USB host interface control unit 11 to the USB device control units 14, 15, 16 and 17, through the SPI communication protocol (such as master-slave switching signal), thereby, by way of the SPI master device interface of the serial peripheral interface (SPI) master control unit, the capability of controlling plural SPI slave devices can be switched, and the SPI slave device interfaces are installed on the plural universal serial bus (USB) host interface control units to be extended, so as to achieve the object of extending the peripheral device with USB interface via the SPI interface. For example, through the SPI communication protocol, the SPI master control unit 13 controls to assign the signal of the USB host interface control unit 11 to the USB device control unit 14, whereby the signals from the keyboard with USB interface 111 and the mouse with USB interface 112, which connect to the USB host interface control unit 11, can be transmitted to the USB device control unit 14 via the SPI, and then transmitted to the computer 142 via the USB hub 141, and whereby the keyboard with USB interface 111 and the mouse with USB interface 112 can control the computer 142. Of course, the SPI master control unit 13 also can assign the signal from the USB host interface control unit 11 to the other of the USB device control units 15, 16 and 17. So long as the serial peripheral interface (SPI) master control unit can afford the switching operation under the master-slave architecture, the peripheral device with USB interface of the USB host interface control unit 11 can be extended without limitation in theory.

The USB switch 12 can connect to the device with USB interface, such as the storage devices 121 and 122, the USB hubs, or the like, and the USB switch 12 electrically connects to the SPI master control unit 13 and the USB hubs 141, 151, 161 and 171. The USB switch 12 is controlled by the SPI master control unit 13, so as to assign the signals from the storage devices with USB interface 121 and 122, which connect to the USB switch 12, to the USB hubs 141, 151, 161 and 171. Certainly, the signals from the storage devices with USB interface 121 and 122, which connect to the USB switch 12, also can be assigned to the other of the USB hubs 141, 151, 161 and 171, for example, the signal of the storage device with USB interface 121 is assigned to the USB hub 141, and the signal of the storage device with USB interface 122 is assigned to the USB hub 151. Thereby, the computer 142 accesses the storage device with USB interface 121, and the computer 152 accesses the storage device with USB interface 122.

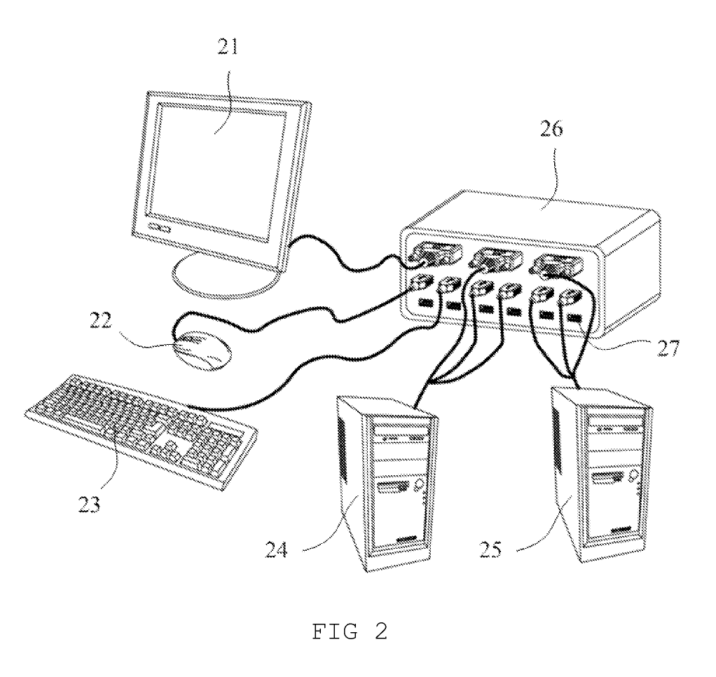

FIG. 2 is a schematic view, showing an embodiment of the KVM switcher applying a KVM switcher to extend USB host interface via serial peripheral interface (SPI) according to the present invention, including a screen 21, a mouse with USB interface 22, a keyboard with USB interface 23, computers 24 and 25, a KVM switcher 26, and an USB interface 27. On the KVM switcher 26, there are plural display interfaces and the USB interface 27. The peripheral devices, such as the screen 21, the mouse 22 and the keyboard 23, electrically connect to the KVM switcher 26, and the KVM switcher 26 has the corresponding transmission line connecting to the computers 24 and 25, for individual peripheral device. In the KVM switcher 26, a KVM switcher with ability to extend the USB host interface via the serial peripheral interface (SPI) is provided, thus the mouse with USB interface 22 and the keyboard with USB interface 23 electrically connect to the USB host interface control unit in the KVM switcher with ability to extend the USB host interface via the serial peripheral interface (SPI); and the transmission line connecting to the computers 24 and 25 connects to the USB hub, whereby the switching function for the peripheral device, such as the keyboard and mouse, is realized. In addition to the switching operation for the keyboard 23 and the mouse 22, more USB interfaces 27, which electrically connect to the USB switch of the KVM switcher with ability to extend the USB host interface via the serial peripheral interface (SPI), are installed in the KVM switcher 26, to provide the switching, accessing and storing device for the computers 24 and 25.

The present invention has the following advantages:

1. The KVM switcher with ability to extend the USB host interface via the serial peripheral interface (SPI) according to the present invention employs the SPI communication protocol suitable for the switching system, so long as the serial peripheral interface (SPI) master control unit can afford the switching operation under the master-slave architecture, the peripheral device with USB interface of the USB host interface control unit 11 can be extended without limitation in theory; and

2. The KVM switcher with ability to extend the USB host interface via the serial peripheral interface (SPI) according to the present invention employs the SPI communication protocol to realize the advantages of SPI, including full-duplex, high bandwidth, brief circuit, and simple control, and the control circuits and cost required for extending the USB host interface control unit 11 are significantly reduced.

What is claimed is:

1. A KVM switcher with ability to extend universal serial bus (USB) host interface via serial peripheral interface (SPI), including:
a serial peripheral interface (SPI) master control unit, equipped with a SPI master device interface; and
at least one universal serial bus (USB) host interface control unit, equipped with an USB interface connecting to at least one peripheral device with USB interface, and equipped with SPI and SPI slave device interface connecting to the SPI master device interface of the serial peripheral interface (SPI) master control unit;
characterized in that the SPI master device interface of the master control unit can switch the capability of controlling the plural SPI slave devices via serial peripheral interface (SPI), and through installing the SPI slave device interface on the plural universal serial bus (USB) host interface control units to be extended, the object of extending peripheral device with USB interface via SPI interface is achieved.

2. The KVM switcher with ability to extend universal serial bus (USB) host interface via serial peripheral interface (SPI) as claimed in claim 1, wherein the multi-computer (KVM) switcher further includes at least one USB device control unit, and the USB device control unit directly or indirectly electrically connects to a computer, and is equipped with a SPI slave device interface, and the SPI slave device interface of each of the USB device control unit electrically connects to the SPI master device interface of the SPI master control unit, and the SPI slave device interface of the USB host interface control unit.

3. The KVM switcher with ability to extend universal serial bus (USB) host interface via serial peripheral interface (SPI) as claimed in claim 2, wherein the SPI master control unit, the USB host interface control unit, and the at least one USB device control unit communicate via SPI signals; the SPI master control unit can switch and select a specific USB device control unit among the at least one USB device control unit, and assign the signal of the USB host interface control unit to the specific USB device control unit, so that the peripheral device with USB interface connecting to the USB host interface control unit can connect to the computer corresponding to the specific USB device control unit.

4. The KVM switcher with ability to extend universal serial bus (USB) host interface via serial peripheral interface (SPI) as claimed in claim 1, wherein the peripheral device with USB interface is a keyboard with USB interface or a mouse with USB interface.

5. The KVM switcher with ability to extend universal serial bus (USB) host interface via serial peripheral interface (SPI) as claimed in claim 1, wherein plural USB hubs are further included, and electrically connect to the at least one USB device control unit, respectively, and the at least one USB device control unit indirectly electrically connects to the corresponding computer through the at least one USB hub.

6. The KVM switcher with ability to extend universal serial bus (USB) host interface via serial peripheral interface (SPI) as claimed in claim 1, wherein an USB switch is further included, electrically connects to the SPI master control unit and the at least one USB hub, and connects to the at least one device with universal serial bus (USB) interface, and the SPI master control unit can control the USB switch to assign the signal of the device with universal serial bus (USB) interface to the at least one USB hub.

7. The KVM switcher with ability to extend universal serial bus (USB) host interface via serial peripheral interface (SPI) as claimed in claim 6, wherein the device with USB interface is a storage device with USB interface.
